(19) United States
(12) Patent Application Publication
(10) Pub. No.: US 2025/0038286 A1
(43) Pub. Date: Jan. 30, 2025

(54) SYSTEMS FOR REMOVING DISCHARGE PRODUCTS FROM METAL-AIR BATTERY CATHODES AND METAL-AIR BATTERIES CONTAINING THE SAME

(71) Applicant: Toyota Motor Engineering & Manufacturing North America, Inc., Plano, TX (US)

(72) Inventors: Timothy S. Arthur, Ann Arbor, MI (US); Xiaoshi Su, Ann Arbor, MI (US); Debasish Banerjee, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/225,225

(22) Filed: Jul. 24, 2023

(51) Int. Cl. H01M 10/54; H01M 4/134; H01M 12/02; H01M 12/08

(52) U.S. Cl. CPC H01M 10/54; H01M 4/134; H01M 12/02; H01M 12/08

(57) ABSTRACT

A metal-air battery includes an anode, a porous cathode, a separator between the anode and the porous cathode, a liquid electrolyte, and at least one acoustic device. The acoustic device produces acoustic waves at a frequency that pumps the liquid electrolyte through and into flowing contact with the porous cathode such that a discharge product is removed from the porous cathode. An accumulation compartment where the discharged product is collected after being removed from the porous cathode can also be included.

### TECHNICAL FIELD

The present disclosure relates generally to batteries, and more particularly, to discharge products formed within metal-air batteries.

### BACKGROUND

Metal-air batteries, such as lithium-air (Li-air) batteries, suffer from capacity fading and low current density due to the deposition of discharge products on the surface as well as inside pores of the battery cathode. And the deposition of discharge products prevents continuous discharge through inactivation of the cathode surface.

The present disclosure addresses issues related to solid discharge products in metal-air batteries, and other issues related to metal-air batteries.

### SUMMARY

This section provides a general summary of the disclosure and is not a comprehensive disclosure of its full scope or its features.

In one form of the present disclosure, a metal-air battery includes an anode, a porous cathode, a separator between the anode and the cathode, a liquid electrolyte, and at least one acoustic device. The acoustic device produces acoustic waves at a frequency that pumps the liquid electrolyte through and into flowing contact with the porous cathode such that a discharge product is removed therefrom.

In another form of the present disclosure, a lithium-air battery includes a lithium anode, a porous cathode, where the porous cathode receives a supply of oxygen gas, a separator between the lithium anode and the porous cathode, a liquid electrolyte, and at least one acoustic device. The acoustic device produces acoustic waves at a frequency that pumps the liquid electrolyte through and into flowing porous contact with the cathode such that a lithium peroxide discharge product is removed therefrom.

In still another form of the present disclosure, a method for collecting a discharge product of a metal-air battery is disclosed. The method includes controlling at least one acoustic device to produce acoustic waves that cause a liquid electrolyte of the metal-air battery to flow into contact with a porous cathode of the metal-air battery such that a discharge product formed on a surface of the porous cathode is dislodged therefrom. The method further includes receiving a discharge product in response to the liquid electrolyte flowing into porous contact with the cathode. Moreover, the method includes collecting the discharge product in an accumulation compartment.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 is a perspective view of a battery according to the teachings of the present disclosure;

FIG. 2 is a perspective view of a battery that includes an accumulation compartment according to the teachings of the present disclosure;

FIG. 3 is a plot of voltage versus capacity for a lithium air battery according to the teachings of the present disclosure;

FIG. 4 is a non-limiting example of an acoustic system that is associated with controlling acoustic devices of a battery to remove a discharge product of a battery; and

FIG. 5 is a flow chart for a method that is associated with removing discharge products from a battery.

### DETAILED DESCRIPTION

The present disclosure provides a metal-air battery with at least one acoustic device. Metal-air batteries with porous cathodes are prone to suffering from capacity fading and low current density as a result of discharge product deposition on the surface of and in the pores of the porous cathodes. Particularly, the accumulation of discharge products in a porous cathode (also referred to herein simply as “cathode”) of a metal-air battery prevents continuous discharge of the battery. Accordingly, in one form of the present disclosure, a metal-air battery including an anode, a porous cathode, a separator between the anode and the cathode, a liquid electrolyte and at least one acoustic device is disclosed. The acoustic device produces acoustic waves at a frequency that pumps the liquid electrolyte through and into flowing contact with the cathode such that a discharge product formed during discharging of the metal-air battery is removed from the cathode.

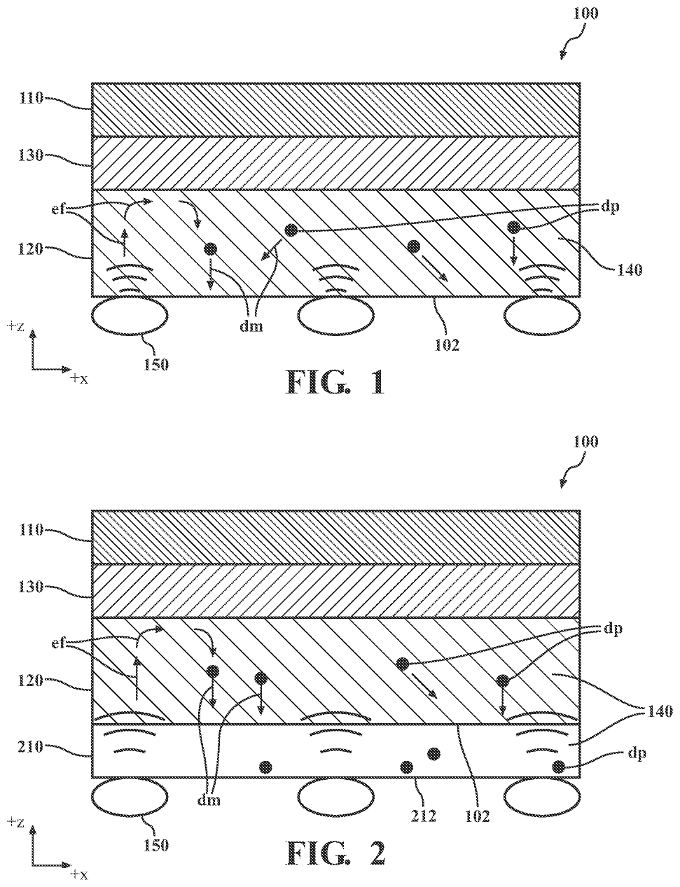

Referring to FIG. 1, one non-limiting example of a metal-air battery 100 that produces a solid discharge product is shown. The metal-air battery 100 includes an anode 110, a porous cathode 120, and a separator 130 between the anode 110 and the cathode 120. The metal-air battery 100 further includes a liquid electrolyte 140 that is in contact with the cathode 120. The metal-air battery 100 is, for example, a lithium-air (Li-air) battery, a zinc-air (Zn-air) battery, a lithium-oxygen (Li—O₂) battery, or any other metal-air battery comprising an anode 110, a porous cathode 120, a liquid electrolyte 140, and that produces a solid discharge product. As used herein, the phrase “discharge product” refers to a material (e.g., an oxide) that forms within a metal-air battery (e.g., on a surface of a cathode) during discharging of the metal-air battery. The anode 110, in non-limiting examples, is a metallic lithium or zinc anode depending on the metal-air battery type.

In some variations, the porous cathode 120 is a porous carbon material, a transition metal oxide, or a mixture of a porous carbon material and transition metal oxide, depending on the metal-air battery type. The liquid electrolyte 140 is, in one or more non-limiting examples, an organic solvent with lithium salts, an ionic liquid electrolyte, a potassium hydroxide electrolyte, a sodium hydroxide electrolyte, an aqueous electrolyte with zinc salts, an alkaline electrolyte with neutral salts, etc., depending on the metal-air battery type. In one or more variations, the separator 130 is a porous material (e.g., polyolefin-based materials, ceramic materials, composite membranes, etc.) that allows for the diffusion of air and the transportation of ions, such as lithium or zinc ions, between the anode 110 and the cathode 120.

In some variations, the metal-air battery 100 is a Li-air battery, the anode 110 is metallic lithium, the cathode 120 is a porous carbon material (e.g., activated carbon, carbon nanotubes, graphene, carbon aerogels, carbon foam, etc.), and the liquid electrolyte 140 is an organic solvent with lithium salts. In at least one variation, the solvent is formed from or includes one or more of dimethyl sulfoxide, dimethyl carbonate, propylene carbonate, and the lithium salt is one or more of lithium bis(trifluoromethanesulfonyl)imide or lithium perchlorate) or an ionic liquid electrolyte (e.g., N-methyl-N-butylpyrrolidinium, bis(trifluoromethanesulfonyl)imide, and N-butyl-N-methylpyrrolidinium bis(fluorosulfonyl)imide).

In some variations, the metal-air battery 100 is a Zn-air battery, the anode 110 is metallic zinc, the porous cathode 120 is a gas diffusion electrode that includes a catalyst, such as a carbon material and a transition metal oxide (e.g., manganese oxide, cobalt oxide, nickel oxide, iron oxide, etc.), and the liquid electrolyte 140 includes one or more of potassium hydroxide electrolyte, a sodium hydroxide electrolyte, and an aqueous electrolyte with zinc salts. In any case, the metal-air battery 100 includes the anode 110, the porous cathode 120, the separator 130, and the liquid electrolyte 140 that is appropriate for the specific metal-air battery 100. Moreover, the porous cathode 120 of the metal-air battery 100 receives a supply of oxygen gas to facilitate the electrochemical reactions of the metal-air battery 100.

In one or more variations, the metal-air battery 100 includes at least one acoustic device 150. The at least one acoustic device 150 produces acoustic waves at a frequency that pumps the liquid electrolyte 140 of the metal-air battery 100 through and into flowing contact with the cathode 120 as illustrated by the arrows labeled ‘ef’ in the figures. In addition, flow of the liquid electrolyte 140 moves a discharge product ‘dp’ within the cathode 120 as illustrated by the arrows labeled ‘dm’ such that the discharge product dp can be and is removed from the cathode 120. For example, in some variations, the discharge product dp is formed on a surface of the cathode 120 and the flowing liquid electrode 150 dislodges and/or removes the discharge product dp from the surface of the cathode 120 such that the discharge product dp moves from a first position within the cathode 120 to at least one second position within or outside of the cathode 120.

In some variations, the discharge product dp is a “hard” solid discharge product such as a solid oxide that is produced as a result of electrochemical reactions that occur during discharge of the metal-air battery 100. In other variations, the discharge product dp is a soft or semi-solid discharge product such as a sludge or gel that is produced as a result of electrochemical reactions that occur during discharge of the metal-air battery 100. As an example, the discharge product for a Li-air battery is lithium peroxide or lithium oxide, and the discharge product for a Zn-air battery is zinc oxide.

In one or more non-limiting examples, the at least one acoustic device 150 produces or generates a frequency that is substantially equal to a channel resonance of the liquid electrolyte 140. As used herein, the phrase “channel resonance”, also known as “channel resonance frequency” refers to an acoustic frequency or a limited range of acoustic frequencies that pump a given electrolyte through a given porous cathode. Accordingly, the channel resonance of the liquid electrolyte 140 differs depending on one or more of the composition of the liquid electrolyte 140, the concentration of ions in the liquid electrolyte 140, the viscosity of the liquid electrolyte 140, the temperature of the liquid electrolyte 140, the geometry of the anode 110, the geometry of the cathode 120, and the geometry of the separator 130, etc. In non-limiting examples, the at least one acoustic device 150 is any device that produces acoustic waves at the channel resonance of the liquid electrolyte, such as an ultrasonic device (e.g., a transducer), a loudspeaker, etc.

In any case, the at least one acoustic device 150 is attached to an exterior surface 102 of the metal-air battery 100 adjacent to the cathode 120 in any matter that allows for the at least one acoustic device 150 to generate acoustic waves with a frequency that is substantially equal to the channel resonance of the liquid electrolyte 140 and allows for the generated acoustic waves to propagate into the cathode 120. In addition, generating acoustic waves at the frequency that is substantially equal to the channel resonance results in the liquid electrolyte 140 flowing into contact with and/or within the cathode 120. The at least one acoustic device 150 may be attached to any side of the metal-air battery 100 that is adjacent to the cathode 120, and any number of acoustic devices 140 spaced apart in any suitable manner may be utilized. For example, and although FIG. 1 illustrates the metal-air battery 100 as including three acoustic devices 140 attached to an underside (−z direction) of the metal-air battery 100 adjacent to the cathode 120, any number of acoustic devices 140 may be attached to the metal-air battery 100 in any manner that generates the appropriate acoustic waves for the particular liquid electrolyte 140 and cathode 120 present in the metal-air battery 100.

Referring to FIG. 2, another non-limiting example of the metal-air battery 100 is shown. As previously discussed, the metal-air battery 100 includes the anode 110, the porous cathode 120, the separator 130, a liquid electrolyte 140, and the at least one acoustic device 150. And in one or more variations, the metal-air battery 100 further includes an accumulation compartment 210 configured to collect or accumulate discharged products dp removed from the cathode 120.

The accumulation compartment 210 is attached to the exterior surface 102 of the metal-air battery 100 and is adjacent to and in fluid communication with the cathode 120. The accumulation compartment 210 is, in one or more variations, attached to the metal-air battery 100 using any conventional attachment method, such as adhesives, magnets, straps, brackets, clips, etc. The accumulation compartment 210 may further be integrated with the metal-air battery 100. For example, in some variations the accumulation compartment 210 is spaced apart from the cathode 120 and is fluid communication therewith via a tube, duct, and the like (not shown). Moreover, the accumulation compartment 210 is any storage container/bin that can receive the discharge products produced by discharging the metal-air battery 100, such as a plastic container, a steel container, a glass container, a mesh netting, etc. And in some variations, the accumulation compartment 220 contains the liquid electrolyte 140 as illustrated in FIG. 2.

In one or more variations, the at least one acoustic device 150 is attached to an exterior surface 212 of the accumulation compartment 210. The at least one acoustic device 150 may be attached to any side of the accumulation compartment 210 such that acoustic waves generated by the at least one acoustic device 150 propagate into the cathode 120. In addition, any number of acoustic devices 140 spaced apart in any suitable manner may be utilized. For example, and although FIG. 2 illustrates the metal-air battery 100 as including three acoustic devices 140 attached to the underside (−z direction) of the accumulation compartment 210, any number of acoustic devices 140 may be attached to the accumulation compartment 210 in any manner that generates acoustic waves with a desired frequency for the particular liquid electrolyte 120 present in the metal-air battery 100.

In any case, in some variations, the accumulation compartment 210 is located beneath (−z direction) the cathode 120 and receives the discharge product dp in response to a gravitational force acting on the discharge product and/or pumping of the electrolyte 140 through the cathode 120. Specifically, pumping the liquid electrolyte 140 through the cathode 140 via the one or more acoustic devices 140 removes the discharge product from a surface of the cathode 120 and gravitational force assists in moving the discharge product dp from the cathode 120 to the accumulation compartment 210. In one or more variations, the discharge product dp is manually removed from the accumulation compartment 210 by detaching the accumulation compartment 210 from the metal-air battery 100 and emptying the accumulation compartment 210. In the alternative, or in addition to, the accumulation compartment 210 includes a door, flap, or any movable surface (not shown) that allows the accumulation compartment 210 to open and release the discharge product dp while still remaining attached to the metal-air battery 100.

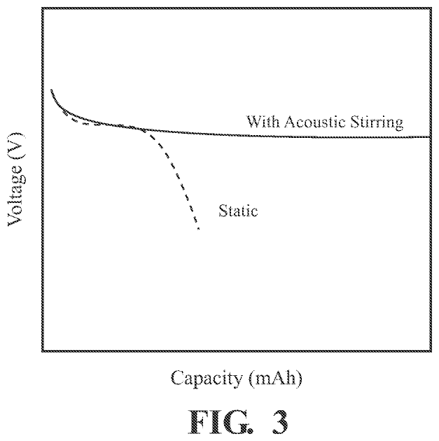

Referring to FIG. 3, a plot of voltage versus capacity is shown for a Li-air battery under static (dashed line) and flowing (solid line) liquid electrolyte operating conditions. The static liquid electrolyte operating condition corresponds to the discharge operation of the Li-air battery without the use of an acoustic device. The flowing liquid electrolyte operating condition corresponds to the discharge operation of the same Li-air battery with the use of an acoustic device that produces acoustic waves at a frequency that pumps the liquid electrolyte through and into flowing contact with the cathode (also referred to as “acoustic stirring”) such that a discharge product is removed from the cathode. As shown in FIG. 3, discharging of the Li-air battery in the static liquid electrolyte operating condition is terminated earlier than in the flowing liquid electrolyte operating condition due to the accumulation of solid discharge products on the surface(s) of the cathode in the static liquid electrolyte operating condition. By using an acoustic device to cause or force the liquid electrolyte of the Li-air battery to flow within the cathode, the Li-air battery exhibits an increase in capacity due to a reduction of blocked pores in the cathode. In this way, utilizing an acoustic device to cause or force the liquid electrolyte to flow into and through the battery cathode allows the Li-air battery to operate longer than without the use of the acoustic device.

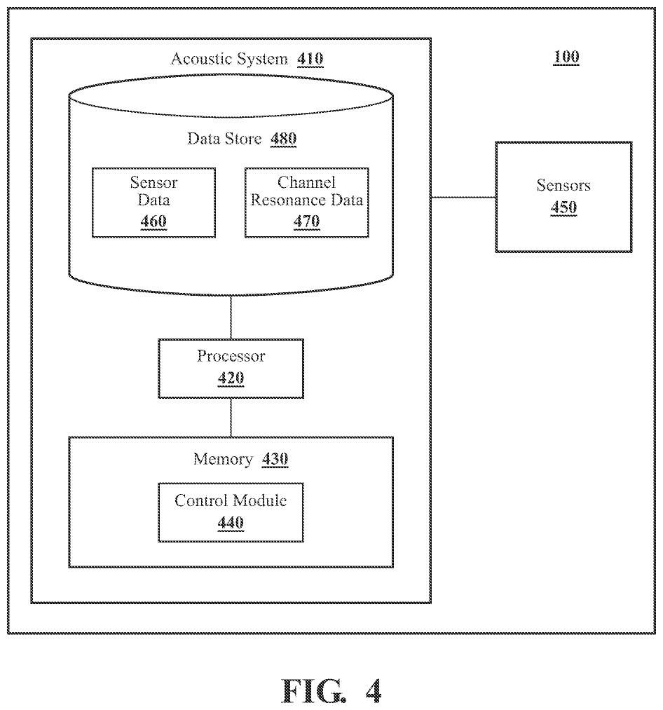

Referring to FIG. 4, an acoustic system 410 will be discussed in relation to the metal-air battery 100 described in FIGS. 1 and 2. In non-limiting examples, the battery 100 includes the acoustic system 410 that is implemented to perform methods and other functions as disclosed herein relating to improving the removal of discharge products from the battery 100. The acoustic system 410 is shown as including a processor 420. The processor 420 may be a part of the acoustic system 410, the acoustic system 410 may include a separate processor from the processor 420 of the battery 100, or the acoustic system 410 may access the processor 420 through a data bus or another communication path. In one variation, the acoustic system 410 includes a memory 430 that stores a control module 440. The memory 430 is a random-access memory (RAM), read-only memory (ROM), a hard-disk drive, a flash memory, or other suitable memory for storing the control module 440. The control module 440 is, for example, computer-readable instructions that when executed by the processor 420 cause the processor 420 to perform the various functions disclosed herein.

The control module 440 generally includes instructions that function to control the processor 420 to receive data inputs from one or more sensors 450 (e.g., flow sensors, pressure sensors, voltage sensors, etc.) of the battery 100. The inputs are, in one or more variations, information associated with the liquid electrolyte 140 of the battery 100 and/or the voltage of the battery 100 during discharge. As provided for herein, the control module 440 acquires sensor data 460 that includes at least the velocity or flow rate of the liquid electrolyte 140 of the battery 100 at acoustic wave frequencies produced by the at least one acoustic device 150 of the battery 100 and/or the voltage of the battery 100 during discharge.

Accordingly, the control module 440, in one embodiment, controls the respective sensors to provide the data inputs in the form of the sensor data 460. Additionally, while the control module 440 is discussed as controlling the various sensors 450 to provide the sensor data 460, in one or more variations, the control module 440 can employ other techniques to acquire the sensor data 460 that are either active or passive. For example, the control module 440 may passively sniff the sensor data 460 from a stream of electronic information provided by the various sensors to further components within the battery 100. Thus, the sensor data 460, in one or more non-limiting examples, represents a combination of perceptions acquired from multiple sensors.

Moreover, in one or more non-limiting examples, the acoustic system 410 includes a data store 480. In one configuration, the data store 480 is a database. The database is, in one variation, an electronic data structure stored in the memory 430 or another data store that is configured with routines that can be executed by the processor 420 for analyzing stored data, providing stored data, organizing stored data, and so on. Thus, in one non-limiting example, the data store 480 stores data used by the control module 440 in executing various functions.

In one variation, the data store 480 further includes channel resonance data 470 associated with the liquid electrolyte of the battery 100. The channel resonance data 470 includes, for example, the acoustic frequency or a limited range of acoustic frequencies that pump a given liquid electrolyte through a given porous cathode of the battery 100. In one or more non-limiting examples, the channel resonance data 470 is stored in the data store 480 as, for example, a lookup table. The lookup table includes, for example, the channel resonance of the particular liquid electrolyte 140 of the battery 100. As such, in one or more variations, the control module 440 acquires the channel resonance data 470 of the battery 100 via the lookup table, which may be preconfigured by an operator. Alternatively, the control module 440, in one arrangement, acquires the channel resonance data 470 by processing portions of the sensor data 460 about the liquid electrolyte 140 of the battery 100. As an example, the control module 440 may acquire the channel resonance data 470 by acquiring the velocity data of the liquid electrolyte 140 in response to at least one acoustic device 150 of the battery 100 emitting acoustic waves that cause the liquid electrolyte 140 to flow through the cathode 120 of the battery 100.

The control module 440, in one or more variations, is further configured to perform additional tasks beyond controlling the respective sensors to acquire and provide the sensor data 460. For example, the control module 440 includes instructions that cause the processor 420 to control at least one acoustic device 150 of the battery 100 to produce acoustic waves at a frequency that pumps the liquid electrolyte 140 of the battery 100 into flowing contact with the cathode 120. In one or more non-limiting examples, the instructions to control the at least one acoustic device 150 includes instructions to determine the channel resonance of the liquid electrolyte 140. In one approach, the control module 440 may determine the channel resonance of the liquid electrolyte 140 based on the channel resonance data 470 stored in the data store 480 as a lookup table. Further, the control module 440 may determine the channel resonance of the liquid electrolyte 140 by tuning the acoustic waves generated by the at least one acoustic device 150 until the at least one acoustic device 150 pumps the liquid electrolyte 140 into flowing contact with the cathode 120.

In one or more non-limiting examples, the control module 440 controls the at least one acoustic device 150 to produce acoustic waves at the channel resonance of the liquid electrolyte 140 at pre-programmed time intervals or after a predetermine time period has passed. For example, the control module 440 may activate the at least one acoustic device 150 every 30 seconds, one minute, five minutes, etc., depending on the liquid electrolyte 140 and the battery 100. Further, the control module 440 may activate the at least one acoustic device 150 to emit acoustic waves at the channel resonance in response to the voltage of the battery 100 falling below a threshold value. The control module 440 may acquire and process the sensor data 460 to determine the voltage of the battery 100. As an example, the control module 440 may activate the at least one acoustic device 150 when the voltage falls below 1.1-1.2 volts per cell or any other value indicative of the battery 100 losing capacity. Moreover, the control module 440 can activate the at least one acoustic device 150 after the battery 100 has completed a predefined number of discharge cycles (e.g., every discharge cycle, every 2 discharge cycles, or any other number of discharge cycles sufficient to accumulate discharge products). Moreover, the control module 440 can activate when the resistance of the cathode increases by a predefined percentage, such as 20% or more during battery discharge. In any case, the control module 440 activates the at least one acoustic device 150 in response to predefined conditions and/or the sensor data 460.

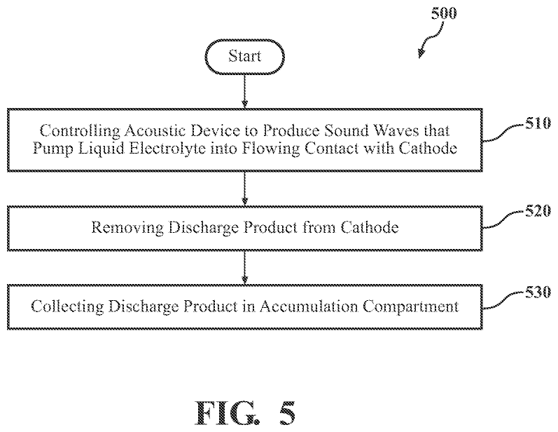

Referring to FIG. 5, a flowchart for a method 500 of removing a discharge product from a metal-air battery is shown. FIG. 5 will be discussed in relation to the metal-air battery 100 described in FIGS. 1 and 2 and from the perspective of the acoustic system 410 of FIG. 4. At 510, the control module 440 controls the at least one acoustic device 150 to produce acoustic waves at a frequency that pumps the liquid electrolyte 140 of the metal-air battery 100 into flowing contact with the cathode 120. In one or more non-limiting examples, controlling the at least one acoustic device 150 includes determining the channel resonance of the liquid electrolyte 140. The control module 440 may determine the channel resonance of the liquid electrolyte 140 by accessing the channel resonance data 470 stored in the data store 480 in the form of a look-up table. In one or more variations, the control module 440 determines the channel resonance by tuning the acoustic waves generated by the at least one acoustic device 150 until the at least one acoustic device 150 pumps the liquid electrolyte 140 into flowing contact with the cathode 120. In any case, the control module 440 controls the at least one acoustic device 150 to generate acoustic waves at a frequency that is substantially equal to the channel resonance of the liquid electrolyte 140. In one or more variations, the control module 440 controls the at least one acoustic device 150 to activate in response to the voltage of the battery 100 falling below a threshold value, after a predetermined number of discharge cycles, and/or after a predetermined period of time has passed.

At 520, in response to the liquid electrolyte 140 flowing into contact with the cathode 120, the discharge product dp is removed from the cathode 120 on a side of the cathode 120 opposite of the separator 130 and the accumulation compartment 210 collects the discharge product dp at 530. In one or more variations, the accumulation compartment 210 collects the discharge product in response to a gravitational force acting on the discharge product. Specifically, the gravitational force assists in moving the discharge product from the cathode 120 to the accumulation compartment 210. In this way, the at least one acoustic device 150 improves the ability of the metal-air battery 100 to remove discharge products from the cathode 120.

The preceding description is merely illustrative in nature and is in no way intended to limit the disclosure, its application, or uses. Work of the presently named inventors, to the extent it may be described in the background section, as well as forms and/or variations of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any form or variation thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one form or variation, or various forms or variations means that a particular feature, structure, or characteristic described in connection with the form or variation or particular system is included in at least one form or variation of the present disclosure. The appearances of the phrase “in one form” or “in one variation” (or variations thereof) are not necessarily referring to the same form or variation. It should be also understood that the various method steps discussed herein do not have to be carried out in the same order as depicted, and not each method step is required in each form or variation.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A metal-air battery, comprising:
an anode;
a porous cathode;
a separator between the anode and the porous cathode;
a liquid electrolyte; and
at least one acoustic device producing acoustic waves at a frequency that pumps the liquid electrolyte through and into flowing contact with the porous cathode such that a discharge product is removed from the porous cathode.

2. The metal-air battery of claim 1, further comprising an accumulation compartment attached to an exterior surface of the metal-air battery adjacent to the porous cathode.

3. The metal-air battery of claim 2, wherein the accumulation compartment receives the discharge product.

4. The metal-air battery of claim 3, wherein the accumulation compartment receives the discharge product in response to a gravitational force acting on the discharge product, and wherein the gravitational force moves the discharge product from the porous cathode to the accumulation compartment.

5. The metal-air battery of claim 2, wherein the at least one acoustic device is attached to an exterior surface of the accumulation compartment.

6. The metal-air battery of claim 1, wherein the anode is at least one of lithium and zinc.

7. The metal-air battery of claim 6, wherein the porous cathode receives a supply of oxygen gas.

8. The metal-air battery of claim 6, wherein the discharge product is at least one of lithium peroxide and zinc oxide.

9. The metal-air battery of claim 1, wherein the frequency is substantially equal to a channel resonance of the liquid electrolyte.

10. A lithium-air battery, comprising:
a lithium anode;
a porous cathode, wherein the porous cathode receives a supply of oxygen gas;
a separator between the lithium anode and the porous cathode;
a liquid electrolyte; and
at least one acoustic device producing acoustic waves at a frequency that pumps the liquid electrolyte through and into flowing contact with the porous cathode such that a lithium peroxide discharge product is removed from the porous cathode.

11. The lithium-air battery of claim 10, further comprising an accumulation compartment attached to an exterior surface of the lithium-air battery adjacent to the porous cathode.

12. The lithium-air battery of claim 11, wherein the accumulation compartment receives the lithium peroxide discharge product.

13. The lithium-air battery of claim 12, wherein the accumulation compartment receives the lithium peroxide discharge product in response to a gravitational force acting on the lithium peroxide discharge product, and wherein the gravitational force moves the lithium peroxide discharge product from the porous cathode to the accumulation compartment.

14. The lithium-air battery of claim 11, wherein the at least one acoustic device is attached to an exterior surface of the accumulation compartment.

15. The lithium-air battery of claim 10, wherein the frequency is substantially equal to a channel resonance of the liquid electrolyte.

16. A method for collecting a discharge product of a metal-air battery, comprising:
controlling at least one acoustic device to produce acoustic waves that cause a liquid electrolyte of the metal-air battery to flow into contact with a porous cathode of the metal-air battery;
receiving the discharge product in response to the liquid electrolyte flowing into contact with the porous cathode; and
collecting the discharge product in an accumulation compartment.

17. The method of claim 16, wherein controlling the at least one acoustic device to produce acoustic waves includes determining a channel resonance of the liquid electrolyte.

18. The method of claim 17, wherein controlling the at least one acoustic device to produce acoustic waves includes producing acoustic waves at a frequency that is substantially equal to the channel resonance of the liquid electrolyte.

19. The method of claim 16, wherein collecting the discharge product includes receiving the discharge product in response to a gravitational force acting on the discharge product, and wherein the gravitational force moves the discharge product from the porous cathode to the accumulation compartment.

20. The method of claim 16, wherein the metal-air battery is a lithium-air battery.
